(19) United States
(12) Patent Application Publication
(10) Pub. No.: US 2002/0152243 A1
(43) Pub. Date: Oct. 17, 2002

(54) Automatic image correcting method on a browser and automatic image correcting system on a browser

(75) Inventors: Koichi Shinozaki, Tokyo (JP); Koichi Kajino, Tokyo (JP); Tetsuro Kimura, Tokyo (JP); Hajime Murayama, Tokyo (JP); Kazumitsu Iidaka, Tokyo (JP)

Correspondence Address: SUGHRUE, MION, ZINN, MACPEAK & SEAS, 2100 Pennsylvania Avenue, N.W., Washington, DC, 20037, US

(73) Assignee: KABUSHIKI KAISHI NIPPON SOFTWARE PRODUCTS

(21) Appl. No.: 10/067,774

(22) Filed: Feb. 8, 2002

(30) Foreign Application Priority Data
Apr. 13, 2001 (JP) 2001-115739

(51) Int. Cl. G06F 17/21

(52) U.S. Cl. 707/526; 707/515

(57) ABSTRACT

To provide a novel automatic image correcting method on a browser and a novel automatic image correcting system on a browser in which image information generally used on a homepage is picked up, this is automatically corrected and processed by, for example, a predetermined image correction and automatically corrected and processed into an image suitable for a user's taste or an easy-to-see image for the user, i.e., for example, an image that is clear and enhanced in recognition degree of the inherent object for the user irrespective of the user will, whereby the user has not to pay any attention to the operation for correcting the image by himself or herself, and a bright image or a clear image or an image suitable for the user may always be inspected on the homepage by the individual user. In order to attain this object, there is provided an automatic image correcting method on a browser, comprising the steps of: analyzing a context of an HTML document currently displayed on the browser to automatically pick up image information (URL) of an image currently displayed; producing a replica of the image and automatically performing image correction to the replica of the image; and automatically displaying the image after the correction on the browser.

### BACKGROUND OF THE INVENTION

The present invention relates to an automatic image correcting method on a browser and an automatic image correcting system on a browser.

In view of the characteristics of a homepage on an internet which is easily laid open for a general user, there are many images having a quality that the image is too dark or unclear.

Also, such images are assumed to be seen by many people but there is almost no attention paid to handicapped people such as people who are weak in color distinction ability.

In order to make images in the homepage on the internet, which are difficult to see, clear and easy-to-see images in which the recognition degree of the inherent objects is enhanced, it is necessary to once store in a local disc the image displayed on the browser, to newly drive the image correcting software and thereafter to correct the image by retrieving the image into the image correcting software by themselves.

In the current situation, for example, when the homepage is inspected or reviewed, the image is not corrected or processed every time or in many cases, there is no idea for correcting the image.

### SUMMARY OF THE INVENTION

Accordingly, an object of the present invention is to provide a novel automatic image correcting method on a browser and a novel automatic image correcting system on a browser in which image information generally used on a homepage is picked up, this is automatically corrected and processed by, for example, a predetermined image correction and automatically corrected and processed into an image suitable for a user's taste or an easy-to-see image for the user, i.e., for example, an image that is clear and enhanced in recognition degree of the inherent object for the user, whereby the user has not to pay any attention to the operation for correcting the image by himself or herself, and a bright image or a clear image or an image suitable for the user may always be inspected on the homepage by the individual user.

In order to attain this and other object, according to the present invention, there is provided an automatic image correcting method on a browser, comprising the steps of: analyzing a context of an HTML document currently displayed on the browser to automatically pick up image information (URL) of an image currently displayed; producing a replica of the image and automatically performing image correction to the replica of the image; and automatically displaying the image after the correction on the browser.

Also, according to the present invention, there is provided an automatic image correcting system on a browser, comprising: image information pick-up means for analyzing a context of an HTML document currently displayed on the browser to automatically pick up image information (URL) of an image currently displayed; image correcting means for automatically performing image correction to the image information obtained by the image information pick-up means or to a replica of the image which is automatically produced by the image information; and correction image display means for automatically displaying the image after the correction on the browser.

### BRIEF DESCRIPTION OF THE DRAWINGS

FIG. 1 is a schematic structural view showing an embodiment of the present invention.

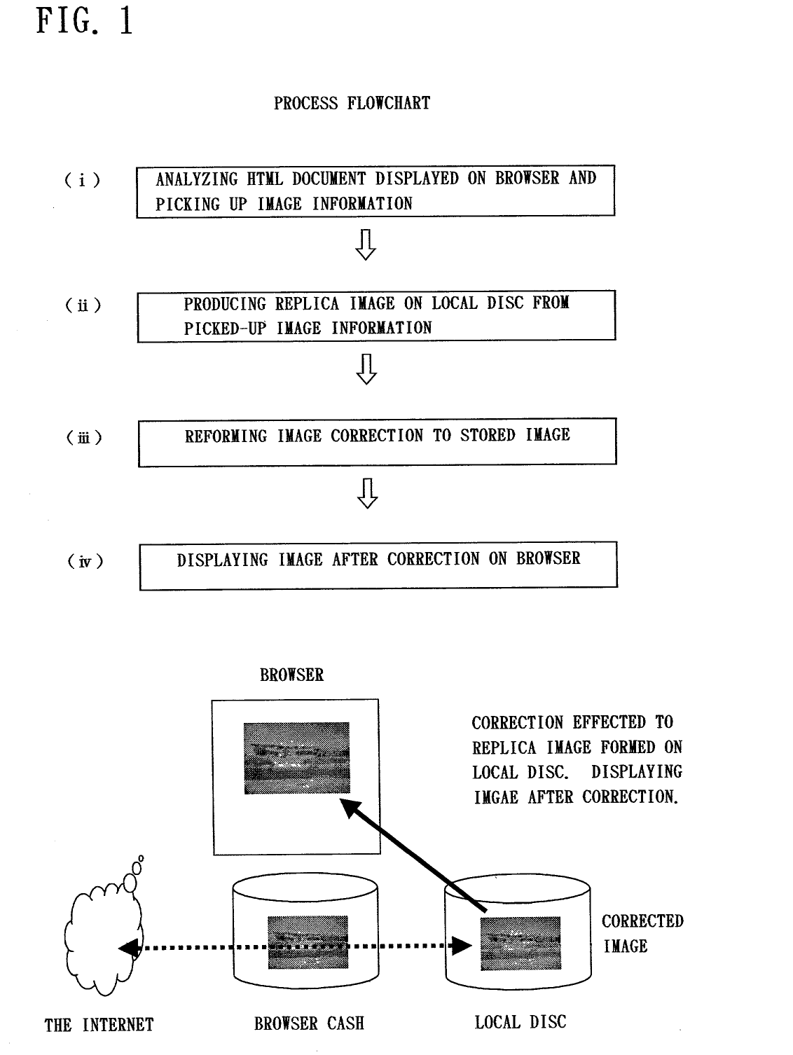

### DESCRIPTION OF THE PREFERRED EMBODIMENTS

A preferred embodiment of the invention (how to embody the invention) will now briefly be described on the basis of the drawings with operational effect.

The context of the HTML document displayed on the browser is automatically analyzed and the image information of the image is picked up. The image information is, for example, replicated and formed on the local disc. A correction of the image is automatically performed to the stored image by, for example, the image correcting software and thereafter the corrected image is automatically displayed on the browser.

Accordingly, it is possible to automatically correct the difficult-to-see image on the browser to the easy-to-see image, i.e., to automatically correct the difficult-to-see image on the browser to the ease-to-see image and display the corrected image without any operation to correct the image by the individual user by himself or herself. Additionally, it is possible to automatically correct and display the image so as to be suitable for the user's taste.

For instance, it is possible to always automatically pick up a dark and difficult-to-see image or a blurred or faded image on the homepage and automatically correct such image to bright and easy-to-see image or clear and distinct image by correcting the blur or fadedness, so that the corrected image is automatically displayed as the image on the homepage at any time.

Also, for instance, depending on a setting by the user in advance, a bright image is always displayed for a user who prefers a bright image by automatically correcting a dark image, while a distinct image is always seen for a user who prefers a vivid color by automatically correcting the dark image so that a brightness of each color and the contrast are enhanced. In addition, for the people who are weak in color recognition ability for a specific color, it is possible to provide more comfortable image at any time due to such setting that the color which is hard to be recognized is automatically corrected so as to be enhanced in deepness, brightness and distinctness.

Thus, in the present invention, even if the user does not perform any operation, it is possible to see the clear image on the homepage. Also, even in case where a dark image or a difficult-to-see image is fed, the image is automatically be corrected, so that the clear image is always seen.

A specific embodiment of the present invention will now be described with reference to the accompanying drawings.

In the embodiment, an example in the case where one HTML (hypertext markup language) document and one image HTML document are accessed will be shown in accordance with correction process steps.

Assume a URL (uniform resource locator) in which the above-described one HTML document and one image HTML document are present as http://www.nsp.co.jp/hosei.html.

1. Image Information Pick-Up Means

(1) Analyzing a HTML Document

When the user accesses http://www.nsp.co.jp/hosei.html, an HTML document is displayed on the browser and sentences of the HTML document displayed on the browser are automatically analyzed, the images used within the HTML are all enumerated and the image information (RRL) to be an object to be corrected is picked up simultaneously with the enumeration.

In the analyzing means, at the time the HTML document is completely displayed on the browser, the analyzing process is started so that the portion having an IMG attribute is picked up into the HTML document for the one HTML document.

Incidentally, the image information is obtained from the IMG attribute. In the case of the HTML document using a frame, the like process by recalling is performed corresponding to the number of the HTML documents used in the frame

(2) Forming a Replica of the Image to Be Corrected

An image replica is formed on the local disc by the enumerated image information (URL).

The replica of the image is performed via a cash of the browser. In the case where the image is present in the cash, the image within the cash is utilized. In the case where the no image is present in the cash, the target image is downloaded to produce the replica while accessing the server.

Incidentally, the “cash” means a technique for high speed process to temporality store data on the homepage once accessed on the local disc (cash data) and to utilize and display the data within the cash upon the next access.

2. Image Correcting Means (Image Correction)

The image correction to convert the difficult-to-see image that has no clear cut into a clear and easy-to-see image that has a clear cut for the replica image is performed.

Also, the browser user's taste of the image is set in advance whereby the image correction suitable for the browser user is automatically performed.

The condition of the image is analyzed by brightness, contrast, tone and the like. The image correction value of the brightness, contrast, tone and the like are calculated. After the calculation, the image correction function is to compensate for the image on the basis of the correction value. In this case, the taste of the browser user is set in advance whereby it is possible to calculate the correction value on which the taste is reflected when the above-described image correction value is calculated.

Incidentally, the above-described series of processes of the image correction are all performed automatically.

In the embodiment, the system is adapted in which the image correction value is calculated for the replica of the image on the basis of the image information (URL) picked up by the image information pick-up means and the correction is effected on the basis of this correction value. However, it is possible to set the correction context in advance and to correct all the image, to be fed from the internet, on the basis of this correction context. Also, it is possible to change or set the correction context in conformity with the user's taste as in the above-described embodiment.

Also, it is possible to set the condition of the image to be corrected, to display the image that meets the condition as the correct image without any correction and to automatically correct the image that does not meet the condition, in accordance with the correction context that is set in advance.

Also, for the people who are weak in color recognition ability, the image fed from the internet is first corrected to an image that has an easy-to-see level for sound people. Thereafter, only a color whose visual recognition degree is enhanced in advance in accordance with the input by the people who are weak in color recognition is corrected to be intensified, bright and large in contrast. Such a two stage correction may be effected. Also, the image correction means may be provided only for the people who is weak in color recognition ability. For example, the correction for people who is weak in color recognition ability for red or the correction for people who is weak in color recognition ability for green or the like may be selected to perform the automatic image correction process.

3. Correction Image Display Means (Correction Image Display)

In order to display the corrected image on the browser, the HTML document within the cash of the browser is changed. As a result, the image within the HTML document of http://www.nsp.co.jp/hosei.html displayed by the user is switched over to be displayed on the above-described browser.

Accordingly, it is possible to perform the automatic image correction immediately after the display of the homepage on the browser and to inspect the image after correction that is suitable for the browser user taste without any operation to correct the image by himself or herself under the condition that the homepage is displayed.

Also, the present invention is applied so that the difficult-to-see color is converted into the easy-to-see color and the easy-to-see image for the individual may be inspected even for the people who is visually handicapped like low color recognition ability people as described above. Thus, the automatic image correction may be ensured on the browser with extremely novel and practical utility and advantage for any person.

Incidentally, with respect to timing for switching the image before correction and the image after correction, immediately after the all the correction for the images to be corrected is completed, all the images that have not yet been corrected are switched to the images after the correction. The overall processing time according to the present invention is for the setup of the personal computer where the CPU is Pentium (3)733 MHx, the memory 256M, the OS is WindowsNT4, Osp6a, and Browser is Internet Explore 5.5. It is confirmed that the overall processing time is 900 msec. under the condition that the file number of the HTML file is one file, the file size is 10 kbyte, the file number of the image file is one file and the file size is 50 kbyte.

Namely, it is confirmed that it does not take one second to complete the automatic correction display operation according to the present invention even in the above-described model, and there is no problem in practical use without any difficulty to see the homepage.

With the above-described structure of the present invention, for example, it is possible to always automatically correct the difficult-to-see image on the browser to the easy-to-see image, i.e., to automatically correct the difficult-to-see image to the easy-to-see image and display the corrected image without any operation to correct the image by the individual user by himself or herself to thereby make it possible to always see the clear image on the homepage, for example, to provide an extremely novel automatic image correction method on a browser and an extremely novel automatic image correction system on a browser in which the image is automatically corrected and the clear image is always seen even if, for example, the dark image or blurred image is fed.

What is claimed is:

1. An automatic image correcting method on a browser, comprising the steps of:
analyzing a context of an HTML document currently displayed on the browser to automatically pick up image information (URL) of an image currently displayed;
producing a replica of the image and automatically performing image correction to the replica of the image; and
automatically displaying the image after the correction on the browser.

2. An automatic image correcting system on a browser, comprising:
image information pick-up means for analyzing a context of an HTML document currently displayed on the browser to automatically pick up image information (URL) of an image currently displayed;
image correcting means for automatically performing image correction to the image information obtained by the image information pick-up means or to a replica of the image which is automatically produced by the image information; and
correction image display means for automatically displaying the image after the correction on the browser.
